(19) United States
(12) Patent Application Publication
(10) Pub. No.: US 2007/0050184 A1
(43) Pub. Date: Mar. 1, 2007

(54) PERSONAL AUDIO CONTENT DELIVERY APPARATUS AND METHOD

(76) Inventors: David M. Drucker, Falls Church, VA (US); Marcus Heth, Locust Grove, VA (US); Xinyu Huang, Great Falls, VA (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/467,354

(22) Filed: Aug. 25, 2006

Related U.S. Application Data
(60) Provisional application No. 60/596,048, filed on Aug. 26, 2005.

(51) Int. Cl. G06F 17/28; G06F 17/00; G06F 3/00

(52) U.S. Cl. 704/3; 715/523; 715/727

(57) ABSTRACT

To create an audio personal newspaper, descriptive information about newspaper articles (such as subject matter, author, source) is extracted from newspaper articles and the text of the newspaper articles is converted into audio files so the user can listen to the content of the newspaper articles. The audio newspaper can be personalized by compiling only the articles matching a user's preferences for subject matter, author, source, and the like. In some embodiments, the audio newspaper may be stored in a data file, which may have advertisements appended to it and which may be stored as a single file so as to prevent the user from skipping over advertisements.

### CROSS-REFERENCE TO RELATED APPLICATION

This application claims the benefit of the U.S. Provisional Application 60/596,048, the entirety of which is hereby incorporated by reference.

### BACKGROUND

The invention relates generally to the conversion of text-based content to audio content, and more particularly to the compilation, storage, and delivery of the converted content to a user.

Portable audio players allow users to listen to content of their choice. The use of audio players for delivering music is also known in the art and audio books allow users to listen to the content of books. Up-to-the-minute, personalized audio news content, however, is not currently available.

Traditional sources of news have certain disadvantages. For example, newspapers can be unwieldy and difficult to read because of the small size of the typeface. Additionally, commuters who drive to work cannot read the newspaper during their commute. Radio news programs provide audio versions of the news, but often radio news stories only provide a cursory discussion of the news, and the listener cannot choose which news clips most interest him or her. In addition, listeners of news radio programs cannot choose the time at which they listen to the news stories presented, as there is no way to pause a radio program or record it for future listening.

Thus, there is a need for an apparatus and method for delivering personalized news content based on a user's preferences that is selectively retrievable by the user.

### SUMMARY OF THE INVENTION

To create an audio personal newspaper, descriptive information about newspaper articles (such as subject matter, author, source) is extracted from newspaper articles and the text of the newspaper articles is converted into audio files so the user can listen to the content of the newspaper articles. The audio newspaper can be personalized by compiling only the articles matching a user's preferences for subject matter, author, source, and the like. In some embodiments, the audio newspaper may be stored in a data file, which may have advertisements appended to it and which may be stored as a single file so as to prevent the user from skipping over advertisements.

### BRIEF DESCRIPTION OF THE DRAWINGS

The invention is described with reference to the accompanying drawings.

FIG. 1 is a block diagram illustrating the entities involved in the provision of an embodiment of the invention.

FIG. 2 is a block diagram illustrating a high-level block diagram of the text content processing functionality according to an embodiment of the invention.

FIG. 3 is a flow chart illustrating the steps text content undergoes as it is processed according to an embodiment of the invention.

FIG. 4 is a block diagram illustrating an audio file according to an embodiment of the invention.

FIG. 5 is a functional block diagram illustrating the transmission of an audio file from the text content processing functionality to an end user's portable electronic device according to an embodiment of the invention.

FIG. 6 is a functional block diagram illustrating the provision of audio content according to an embodiment of the invention.

FIG. 7 is an example of a graphical user interface available to a user according to an embodiment of the invention.

FIG. 8 is a schematic block diagram of an audio file with an advertisement inserted therein, according to an embodiment of the invention.

### DETAILED DESCRIPTION

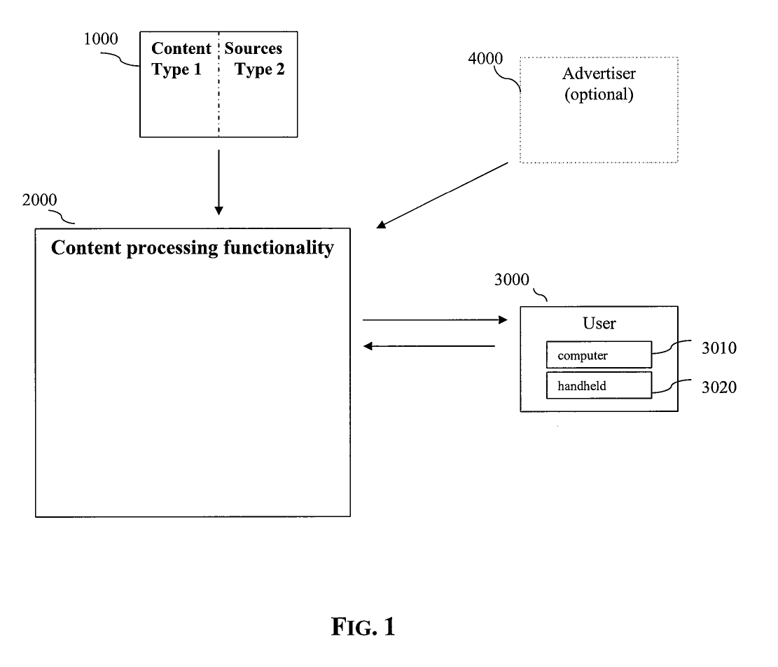

FIG. 1 is a block diagram illustrating the entities involved in the provision of an embodiment of the invention. The content processing functionality 2000 interfaces with content sources of varying form 1000, and end users 3000. The content source provides content items to the content processing functionality. There are many types of content sources. For example, a newspaper may be a content source. A website may be a content source as well. The content source may contain only text content items (e.g., printed text) or it may contain text content items that are associated with other media, such as, for example, audio, video, and/or graphics. Text content items are provided from the content source to the content processing functionality 2000, where the text is converted to audio format and processed for download or transmission to a user 3000.

The user 3000 is an individual who possesses a processor (e.g., a computer) 3010 that can download audio format files and enable the user 3000 to listen to audio format files. The user 3000 may also possess another processor such as, for example, a portable handheld device 3020 that is capable of receiving audio format files and that enables the user 3000 to listen to audio format files.

The user 3000 provides preference information for news articles to the content processing functionality 2000. For example, the user can select the type of content they desire to download based on a variety of factors. The factors include, for example, subject matter, author, source, time frame, geographic location of interest, topics, and the like.

The content processing functionality 2000 can match the user's preference information with descriptive information about the text content items received from the content source. The content source can be one type of descriptive information that identifies a particular text content item. For example, if the content source is a newspaper, and the text content item is an article from the sports section of the newspaper, then the descriptive information associated with that text content item includes (but is not limited to) the source, which is the particular newspaper, and the subject, which is sports. The descriptive information and or preference may be narrowed further. For example, the user may identify a particular sport or team of interest and the descriptive information may be similarly profiled.

In some embodiments, an advertiser can be a content source. For example, the advertiser 4000 provides advertising content to the content processing functionality 2000. In some circumstances, the content processing functionality 2000 converts the content obtained from the advertiser to audio format. Alternatively, the advertiser 4000 could provide content that is already in audio format to the content processing functionality 2000. The content from the advertiser is available to the user 3000 via the content processing functionality 2000.

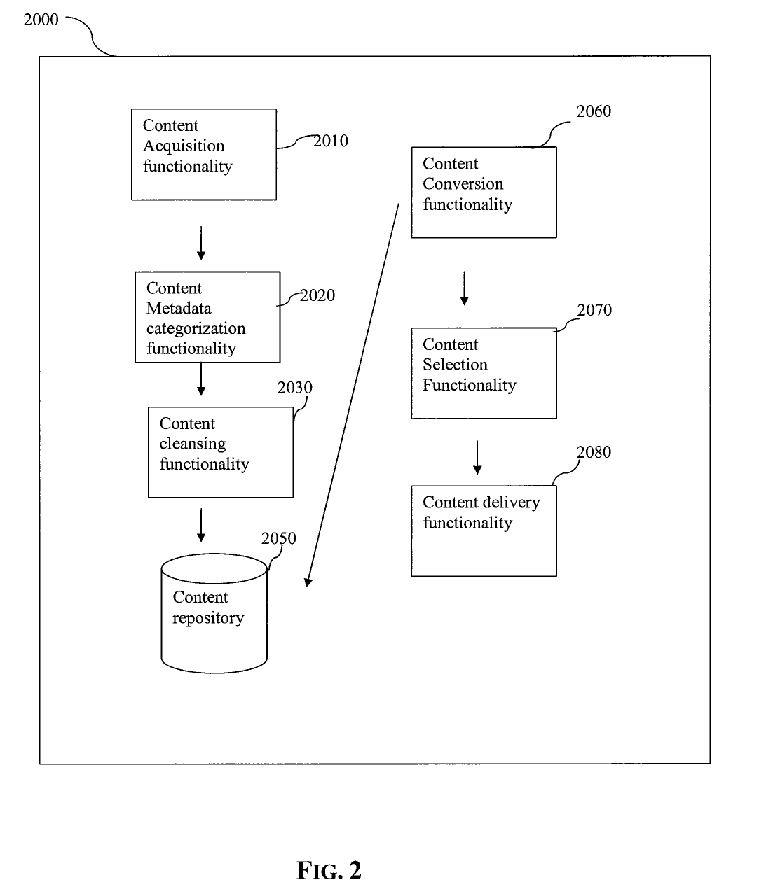

FIG. 2 is a high level block diagram describing the various components of the content processing functionality 2000. The content processing functionality 2000 includes one or more content acquisition functionality 2010, content metadata categorization functionality 2020, content cleansing functionality 2030, content repository capacity 2050, content conversion functionality 2060, content selection functionality 2070, and content delivery functionality 2080. The content acquisition functionality 2010 acquires content from the content sources. Generally, text content items are received by the content acquisition functionality. Where there is information other than text, such as graphics or audio, the content acquisition functionality can remove all information other than the text. Alternatively, the content acquisition functionality can leave the non-text information in place and not convert that information.

The text content item is processed by the content metadata categorization functionality 2020. The content metadata categorization functionality 2020 assigns descriptive information to the text content item based on an analysis of the text content and identifying words or phrases that can be associated with certain categories. The content metadata categorization functionality could be automated or performed by a person who reads the article and assigns descriptive information to the article. For example, if the words home run or World Series appear in an article, then the metadata categorization functionality 2020 could assign the text content item to the categories of “Sports” and “Baseball.”

In some embodiments, the content cleansing functionality 2030 alters the text content item to prepare it for conversion from text form to audio form. The content cleansing functionality can take the form of removing or inserting punctuation marks that are recognizable by the content conversion functionality or removing, inserting, or altering words, letters, or symbols that would not normally be literally spoken if an individual were to read text content item aloud. The content cleansing functionality can also take the form of replacing phrases, words or abbreviations with phonetically accurate representation of these phrases, words, or abbreviations, to more accurately reflect how they would be read. For example the phrase, “Sen. Tom Smith (R—DE)” might be replaced with “Senator Tom Smith, Republican from Delaware”. The content cleansing functionality can also take the form of lexically decomposing one or more sentences to determine the parts of speech (noun, verb, adverb, possessive noun) for each word in the sentence to determine the correct pronunciation of each word and proper phonetic inflection of each word. For example, the phrase “He will take the lead in the presentation” may be replaced with “He will take the leed in the presentation.” Similarly, the phrase “He will take the lead to the factory” may be replaced with “He will take the led to the factory.”

The text content item is converted from text form to audio form by the content conversion functionality 2060. The content conversion functionality 2060 may consist of code stored on a processor that converts text-to-speech, or an audio recording of an individual reading a text content item. Audio content items are stored in a memory in the content repository 2050.

The content selection functionality 2070 compares the descriptive information associated with text content items that have been converted to audio content items with a content preference. For example, some users may prefer to read baseball stories, and the content selection functionality 2070 would ensure that users whose content preferences are set in that manner would receive baseball stories. The content selection functionality 2070 performs the personalization of the delivered/downloaded audio content.

The audio content items selected for a particular user by the content selection functionality are delivered to the user by the content delivery functionality 2080. In some embodiments, the content delivery method is determined by user preferences regarding type of audio files downloaded (e.g., MP3, WAV, etc.), the frequency with which they are downloaded, and the devices they have to receive the audio files.

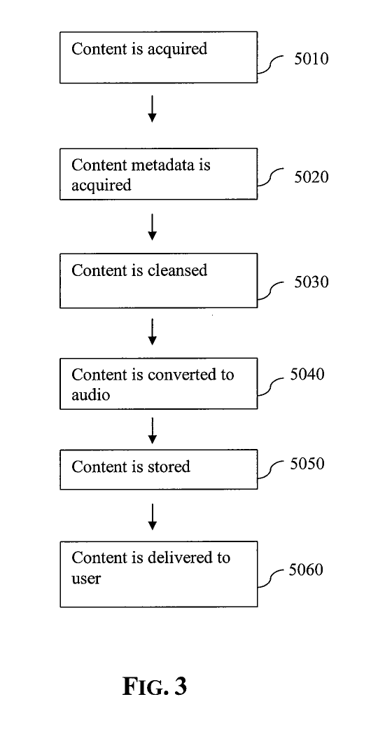

FIG. 3 is a flow chart illustrating the sequence of steps through which content is processed by the invention. Beginning at 5010, content in text form is acquired by the content processing functionality. Descriptive information about the text content item, such as the text's source, author, genre, or other qualities, is next acquired at 5020. In some embodiments, the text content is next altered at 5030 in a manner as discussed above that improves the quality of the audio content item that is ultimately prepared. The text content item is next converted 5040 into an audio file. The text content item is then stored at 5050 in a memory of a content repository 2040. Finally, the text content item in audio form, is delivered to or downloaded by the user 5060.

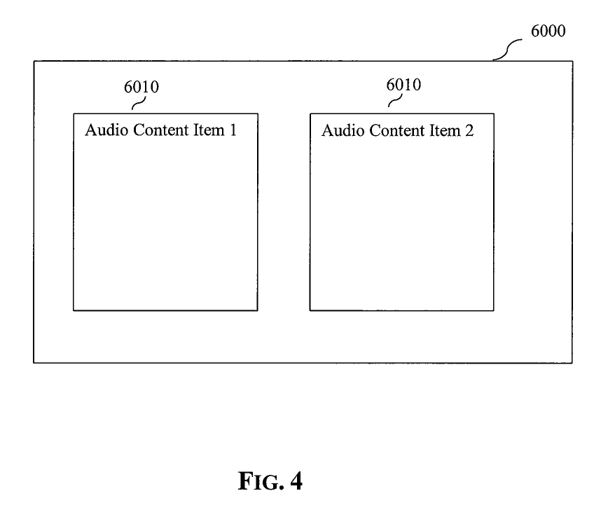

FIG. 4 is a schematic block diagram depicting an audio file 6000 containing text content items 6010 that have been converted to audio form for delivery to the user. The audio file is stored on a computer readable medium and may be any sort of file associated with the playback of audible items (e.g., .MP3, WAV, other audio files). The audio content items 6010 have descriptive information associated with them and are compiled by the content selection functionality.

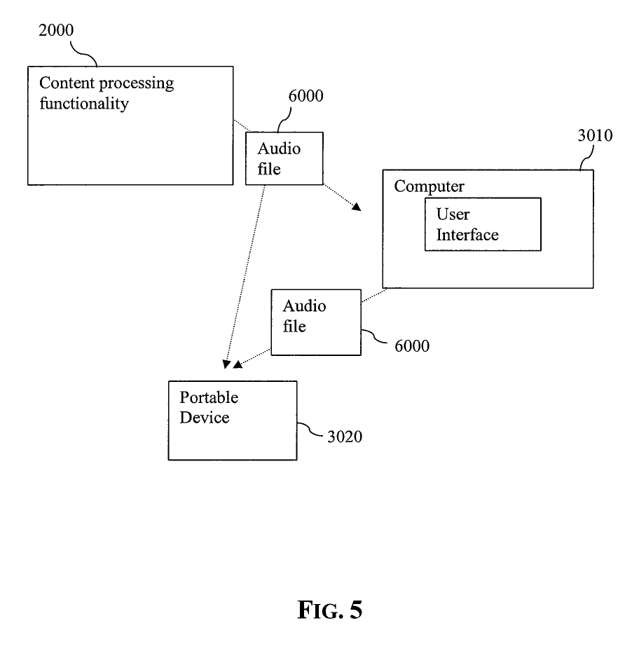

FIG. 5 is a functional block diagram illustrating the transmission of an audio file from the text content processing functionality to an end user's portable electronic device according to an embodiment of the invention. The content processing functionality 2000 generates an audio file 6000. The content processing functionality 2000 delivers the audio file 6000 to a user's computer 3010 or to a user's handheld 3020 according to the user's preferred delivery method. For instance, the user may prefer to have an audio file downloaded once per day. Or the user may prefer to have an audio file downloaded every hour. Similarly, the user may specify the delivery method (e.g., e-mail, download from a website, etc.). The audio file 6000 is then optionally downloaded to the user's handheld portable device 3020 according to the protocol associated with the handheld portable device.

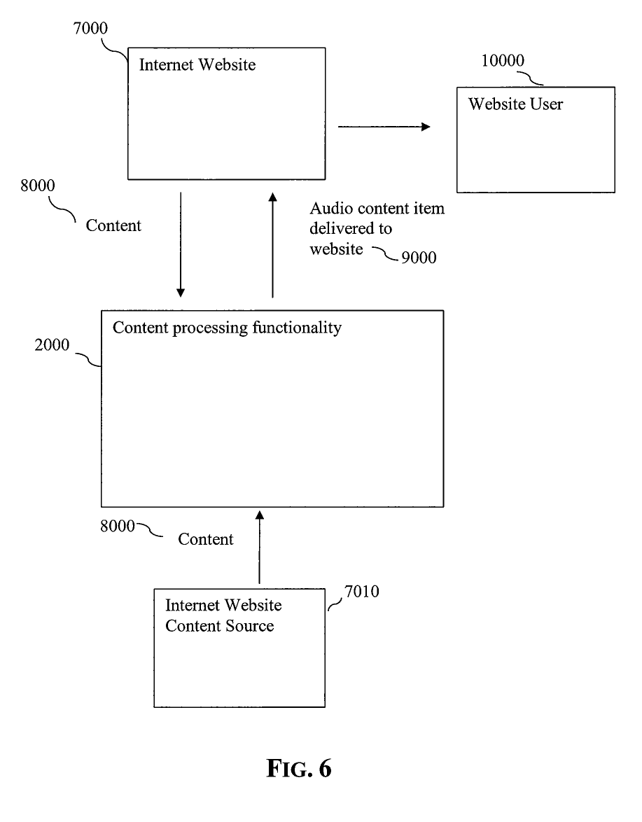

FIG. 6 is a functional block diagram illustrating the provision of audio content according to an embodiment of the invention. In this embodiment, an audio content counterpart to a text content item can be made available on a website in conjunction with the text content item. Accordingly, a content source 7010 associated with the Internet website 7000 or the Internet website 7000 sends content 8000 to the content processing functionality 2000. In some embodiments, the Internet website itself is the content source. The content may be in text form, audio form, or any combination of text and audio and/or graphics/pictures. The content processing functionality 2000 converts the content provided by the Internet website to a desired audio item 9000. The audio content item 9000 is then delivered to the Internet website 7000, where a website user 10000 can access the audio content item 9000.

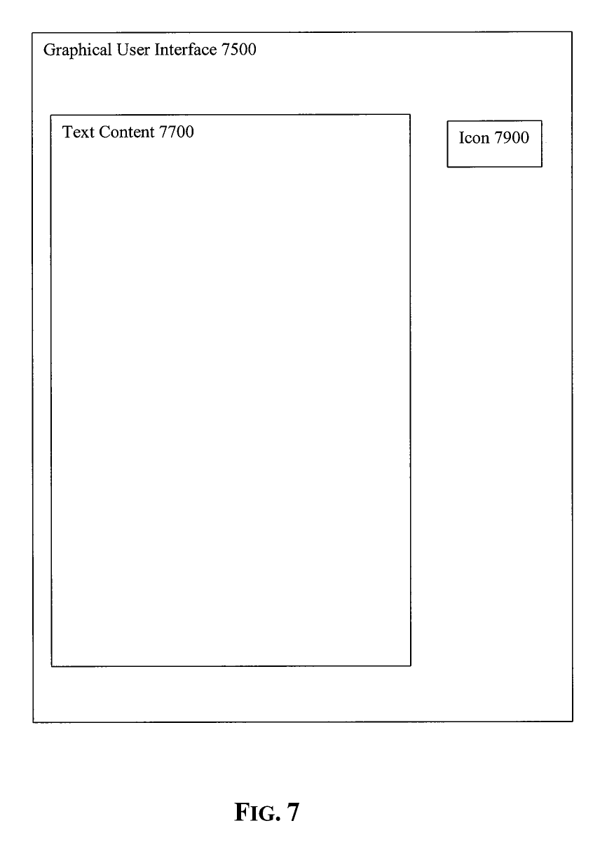

FIG. 7 illustrates an example of a graphical user interface 7500 that is received by a user when navigating the Internet website 7000. On the graphical user interface, the user is presented with the text content 7700 and a separate icon 7900 that can be actuated to listen to audio content or download the audio content. When the user actuates the icon by, for example, clicking on the icon with a mouse, the audio content associated with the displayed text content 7700 is played or downloaded/accessed as discussed above.

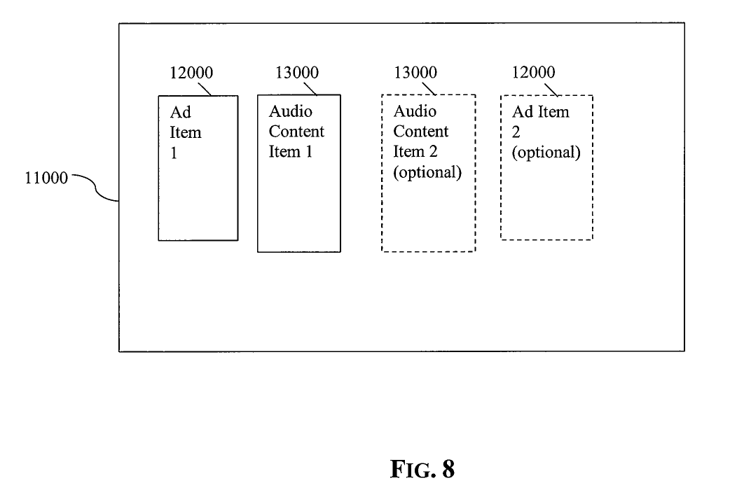

FIG. 8 is a schematic block diagram of an alternative embodiment of the audio file. In some embodiments 11000 the audio file includes at least one advertisement item 12000 in addition to at least one audio content item 13000. In other embodiments, the advertisement has descriptive information associated with it and the advertisement is selected to be included in the audio file 11000 based on the content preferences. In some embodiments, the audible advertisement and the selected/downloaded audio content item are included as part of one audio file. In this manner, the advertisement would have to be downloaded along with the audio content item 13000 and cannot be selectively deleted by the user.

### CONCLUSION

The previous description of the embodiment is provided to enable any person skilled in the art to make or use the invention. While the invention has been particularly shown and described with reference to embodiments thereof, it will be understood by those skilled in art that various changes in form and details may be made therein without departing from the spirit and scope of the invention.

1. A method comprising:
creating for each of a plurality of text content items in text form descriptive information about the text content item based upon the text in the text content item; and
converting each of the text content items from text form to audio form to create a plurality of audio content items; and
associating the descriptive information for each text content item with the corresponding audio content item.

2. The method of claim 1, further comprising:
selecting a subset of the plurality of audio content items for which the associated descriptive information correlates with a content preference; and
delivering said subset of audio content items based on the content preference.

3. The method of claim 1, wherein the converting uses computer-implemented text-to-speech conversion.

4. The method of claim 1, wherein the converting includes altering the text content items prior to a text-to-speech conversion to improve the quality of the audio content items.

5. A method comprising:
selecting from among a plurality of audio content items, each audio content item from the plurality of audio content items being converted from a text content item in text form and having associated therewith descriptive information created based upon text in the text content item, a subset of said audio content items for which the associated descriptive information correlates with a content preference; and
delivering said subset of audio content items based on the content preference.

6. The method of claim 5, wherein the delivering said subset of audio content items is accomplished by delivery methods specified by the user.

7. A computer readable medium encoded with a data file in an audio format, the data file comprising:
a plurality of audio content items, each audio content item from the plurality of audio content items being converted from a text content item in text form and having associated therewith descriptive information created based upon text in the text content item, the descriptive information correlating with a content preference.

8. The computer readable medium of claim 7 wherein the data file additionally comprises advertisements.

9. The computer readable medium of claim 7 wherein the data file additionally comprises advertisements that correlate with a content preference.

10. A method comprising:
providing preference information applicable to text content items; and
receiving a plurality of audio content items, each audio content item being converted from a text content item in text form and having associated therewith descriptive information created based upon text in the text content item, the descriptive information correlating with the preference information.

11. The method of claim 10, wherein the providing preference information includes selecting at least one preference item from among a plurality of predetermined preference items.

12. A method comprising:
receiving from an Internet website provider a content item;
converting the content item to an audio content item;
delivering the audio content item to the Internet website provider in a form accessible by a user of the Internet website.

13. The method of claim 12, wherein said content item received from said Internet website provider is a text content item.

14. The method of claim 12, wherein said content item received from said Internet website provider is a video content item.

15. The method of claim 12, wherein the converting uses computer-implemented text-to-speech conversion.

16. The method of claim 12, wherein the converting includes altering the received content items prior to the conversion to the audio content item to improve the quality of the audio content item.

17. The method of claim 12, wherein the form is an audio file configured to be stored.

18. The method of claim 12, wherein the form is an audio file configured to be played back via the Internet website.

19. A computer readable medium encoded with a data file in an audio format, the audio file comprising:
a plurality of audio content items, each audio content item being converted from a text content item in text form and having associated therewith descriptive information created based upon text in the text content item, the descriptive information correlating with a content preference; and
an audio advertisement appended to the plurality of audio content items.

20. The computer readable medium of claim 19, wherein the audio advertisement appended to the audio content item is selected based on attributes associated with the descriptive information about the audio content item.
